(19) United States
(12) Patent Application Publication
(10) Pub. No.: US 2026/0323191 A1
(43) Pub. Date: Oct. 15, 2026

(54) COLUMN CIRCUIT, CHIP, IMAGE SENSOR AND IMAGING DEVICE

(71) Applicant: MAGVISION SEMICONDUCTOR (BEIJING) INC, Beijing (CN)

(72) Inventors: Kaiyuan WU, Beijing (CN); Yi LIU, Beijing (CN)

(21) Appl. No.: 19/648,725

(22) Filed: Apr. 15, 2026

(30) Foreign Application Priority Data
Apr. 15, 2025 (CN) 202510473273.6

(51) Int. Cl. H04N 25/78

(52) U.S. Cl. CPC H04N 25/78

(57) ABSTRACT

The present invention provides a column circuit, a chip, an image sensor and an imaging device. The column circuit includes M×N bank modules, N readout modules and a data I/O module. A CDS unit of the column circuit is incorporated in the data I/O module. The bank modules receive first data signals, and a second terminal of each bank module is coupled to a first terminal of an associated one of the readout modules. Second terminals of the readout modules are coupled to the data I/O module. The bank modules convert the received first data signals into second data signals, and the readout modules receive the second data signals and send them to the data I/O module. The data I/O module obtains third data signals from CDS processing on the second data signals by the CDS unit therein and outputs the third data signals.

### CROSS-REFERENCE TO RELATED APPLICATION

This application claims the priority of Chinese patent application number 202510473273.6, filed on Apr. 15, 2025, the entire contents of which are incorporated herein by reference.

### TECHNICAL FIELD

The present invention relates to the field of image signal processing (ISP) technology and, in particular, to a column circuit, a chip, an image sensor and an imaging device.

### BACKGROUND

An image sensor is a device that converts optical images into electrical signals and typically includes, amongst others, a pixel array, an analog-to-digital converter (ADC) and a column circuit. For example, reference is made to FIG. 1, a schematic diagram showing data flow in an imaging process. As can be seen from FIG. 1, pixel cells 111 in a pixel array 110 (not shown in FIG. 1; see FIG. 6 described below) are responsible for converting a collected optical image signal into a voltage signal and outputting the voltage signal to an ADC 120. The ADC 120 is responsible for comparing the received voltage signal with a ramp signal and, when the two signals are equal, generating a pulse signal. Upon receiving the pulse signal, a column circuit 130 latches counter data, processes the data in a certain manner, and serially outputs it to an image signal processor (ISP) 150. The ISP 150 carries out extraction and optimization processing (e.g., color correction, gamma correction, etc.) on the received image data, producing an image suitable for display, storage and/or further processing. The image is then output to an interface circuit 160.

Studies show that existing column circuits are large in area and consume much power. Despite successful use in high-performance image sensors, they are not suitable for use in low-cost image sensors.

It should be noted that the information disclosed in this Background section is merely intended to provide a better understanding of the general context of the present invention and should not be taken as an acknowledgement or any form of admission that the information forms part of the common general knowledge of those skilled in the art.

### SUMMARY

In view of the large area and high power consumption problems with column circuits in conventional image sensors, the present invention aims to provide a column circuit, a chip, an image sensor and an imaging device. According to the present invention, the column circuit has a significantly reduced area and good performance and can significantly reduce the cost of an image sensor employing it.

This object is attained by a column circuit for use in an image sensor according to the present invention. The column circuit includes M×N bank modules, N readout modules and a data input/output (I/O) module. The column circuit further includes a correlated double sampling (CDS) unit arranged in the data I/O module. Each bank module has a first terminal configured to receive a first data signal and a second terminal coupled to a first terminal of an associated one of the readout modules. Each readout module has a second terminal coupled to the data I/O module. M is greater than or equal to 2 (i.e., M≥2).

The bank modules are configured to convert the received first data signals into second data signals. The readout modules are configured to receive the second data signals and transmit the received second data signals to the data I/O module. The data I/O module is configured to obtain third data signals from CDS processing by the CDS unit and output the third data signals.

Optionally, the CDS unit may include a plurality of first transistors.

Optionally, each bank module may include, connected in sequence, a first latch and a buffer unit, and each readout module may include, connected in sequence, a flip-flop and a multiplexer, with the data I/O module including, connected in sequence, a transcoder unit, a second latch, the CDS unit and a data interface unit,
the first latch configured to, when receiving a first control signal from the image sensor, latch the first data signal and provide the latched first data signal to the buffer unit, the buffer unit configured to buffer the first data signal and thereby obtain second data signals and provide the second data signals to the flip-flop,
the flip-flop, when receiving a second control signal from the image sensor, passing the second data signals on to the multiplexer, the multiplexer configured to select one of the second data signals according to a third control signal from the image sensor and provide it to the transcoder unit, the transcoder unit configured to transcode the second data signal into a first set of fourth data signals for transmission to the second latch and, after obtaining the first set of fourth data signals, transcode a subsequently received one of the second data signals into a second set of fourth data signals for transmission to the CDS unit, the second latch configured to, when receiving a fourth control signal, latch the first set of fourth data signals, the CDS unit configured to perform CDS processing on the first and second sets of fourth data signals, thereby obtaining the third data signals.

Optionally, the transcoder unit may include a plurality of second transistors.

Optionally, the second data signals may be encoded using Gray code, and the first and second sets of fourth data signals and the third data signals may be binary encoded.

The above object is also attained by a chip for use in an image sensor according to the present invention, on which the column circuit as defined above is integrated.

The above object is also attained by an image sensor according to the present invention, which includes the column circuit or chip as defined above.

Optionally, the image sensor may further include a digital circuit region and a pixel array, wherein the data I/O module of the column circuit is arranged in the digital circuit region;
the pixel array is configured to convert image light signals that it collects into the first data signals; the column circuit is configured to convert the first data signals into the second data signals, which are in turn converted by the data I/O module in the digital circuit region into the third data signals; and an image signal processor (ISP) is configured to process the third data signals and thereby obtain a target image of an object being captured.

Optionally, the data I/O module may be implemented in the digital circuit region using a design tool for digital chips.

The above object is also attained by an imaging device according to the present invention, which includes the column circuit, chip or image sensor as defined above.

The column circuit, chip, image sensor and imaging device of the present invention offer the following advantages over the prior art.

The column circuit is intended for use in an image sensor and includes M×N bank modules, N readout modules and a data I/O module. The column circuit also includes a CDS unit arranged in the data I/O module. Each bank module has a first terminal configured to receive a first data signal and a second terminal coupled to a first terminal of an associated one of the readout modules. Each readout module has a second terminal coupled to the data I/O module. M is greater than or equal to 2 (i.e., M≥2). Additionally, the bank modules are configured to convert the received first data signals into second data signals. The readout modules are configured to receive the second data signals and transmit the received second data signals to the data I/O module. The data I/O module is configured to obtain third data signals from CDS processing by the CDS unit and output the third data signals. Differing from conventional designs with CDS units being incorporated in bank modules, the column circuit of this invention incorporates a CDS unit in a data I/O module. This design fully leverages the fact that the number of data I/O modules is much less than that of bank modules to significantly reduce the number of CDS units, resulting in cost savings and reducing the circuit area that they occupy. Accordingly, the footprint of the column circuit can be significantly reduced while ensuring its good performance. The cost of an image sensor employing this proposed column circuit can be significantly reduced, and the column circuit can be suitably used in low-cost image sensors.

Since the chip, image sensor and imaging device are of the same inventive concept as the column circuit, they have at least all the advantages of the column circuit. Such advantages have been described in detail above in connection with the column circuit and are not repeated herein, and reference is made to the above description for more details.

### BRIEF DESCRIPTION OF THE DRAWINGS

FIG. 1 schematically illustrates data signal flow in an imaging process.

FIG. 2 schematically illustrates data signal flow in a column circuit of an image sensor.

FIG. 3 schematically illustrates the topology of a column circuit in a conventional image sensor.

FIG. 4 shows a schematic block diagram of a column circuit embodying the present invention.

FIG. 5 schematically illustrates the topology of a specific example of a column circuit embodying the present invention.

FIG. 6 shows a schematic block diagram of an imaging device embodying the present invention.

### LIST OF REFERENCE NUMERALS

110 pixel array; 111 pixel cell; 120 ADC; 130, 140 column circuit; 150 ISP; 160 interface circuit;
Bank0, Bank1, Bank2, Bank3, 130A, 141, 141A bank module; R01, R23, 130B, 142, 142A readout module; 170, 143 data I/O module;
131, 141A1 first latch; 132, 1431 transcoder unit; 133, 1432 second latch; 134, 1433 CDS unit; 135, 141A2 buffer unit; 136, 142A1 flip-flop; 137, 142A2 multiplexer; 1434 data interface unit;
GC Gray-code encoded data; BC binary data; CMP comparator data; BLK_EN black-level enable signal; GBL output signal terminal of adjacent readout module;
D1 first data signal; D2 second data signal; D3 third data signal; D4 fourth data signal;
T1 first control signal; T2 second control signal; T3 third control signal; T4 fourth control signal;
180 digital circuit region.

### DETAILED DESCRIPTION

A column circuit, chip, image sensor and imaging device proposed herein will be described in greater detail below with reference to the accompanying drawings. From the following description, advantages and features of the present invention will become more apparent. Note that the figures are provided in a very simplified form not necessarily drawn to exact scale for the only purpose of helping to explain the disclosed embodiments in a more convenient and clearer way. In order that the objects, features and advantages of the present invention can be more apparent and readily understood, reference is to be made to the accompanying drawings. It would be recognized that architectural, proportional, dimensional and other details in the figures are presented only for the purpose of facilitating, in conjunction with the disclosure herein, the understanding and reading of those familiar with the art, rather than being intended to limit conditions under which the present invention can be implemented. Therefore, any and all architectural modifications, proportional variations or dimensional changes that achieve the same or similar benefits and objects as the present invention are considered to fall within the scope of the teachings herein. The specific design features of the invention as disclosed herein, including, for example, specific dimensions, orientations, locations and shapes, will be determined in part by the particular intended application and use environment. Additionally, in the embodiments described below, like reference numerals may be sometimes used to refer to the same or functionally similar elements throughout different figures, while description thereof may not be repeated. In this specification, similar reference numerals and letters refer to similar items in the figures, and thus once an item is defined in one figure, it may not be discussed for following figures. Further, if a method is described herein as including a series of steps, the order of these steps as presented herein is not necessarily the only order in which they can be performed, and some of the stated steps may be omitted and/or other steps not described herein may be added to the method.

It is to be noted that relational terms such as “first,” “second,” and the like may be used herein solely to distinguish one entity or action from another entity or action, without necessarily requiring or implying any actual such relationship or order between such entities or actions, or denoting or implying relative importance of them, or implicitly indicating the number of them. Moreover, the terms “comprise”, “include” and any variations thereof are intended to cover a non-exclusive inclusion, such that a process, method, article, or apparatus that comprises a list of elements is not necessarily limited to those elements, but may include other elements not expressly listed or inherent to such process, method, article, or apparatus. An element preceded by “comprises . . . a” does not, without more constraints, preclude the existence of additional identical elements in the process, method, article, or apparatus that comprises the element. As used herein, the singular forms “a”, “an” and “the” include plural referents, and the term “or” is generally employed in the sense of “and/or”, “a plurality of” of “at least one”, and “at least two” of “two or more”. In addition, the terms “first,” “second,” and “third” are intended only for illustration and are not to be construed as indicating or implying relative importance, or as implicitly indicating the number of the referenced items.

It will be understood that when an element is referred to as being “connected to”, “attached to” or “coupled to” another element, it can be directly connected, attached or coupled to the other element, or intervening elements may also be present. In contrast, when an element is referred to as being “directly connected to” or “directly attached to” another element, there are no intervening elements.

To facilitate understanding and illustration of the present invention, before describing specific embodiments of the proposed column circuit, image sensor and imaging device in detail, primary studies on the present invention are first briefed below.

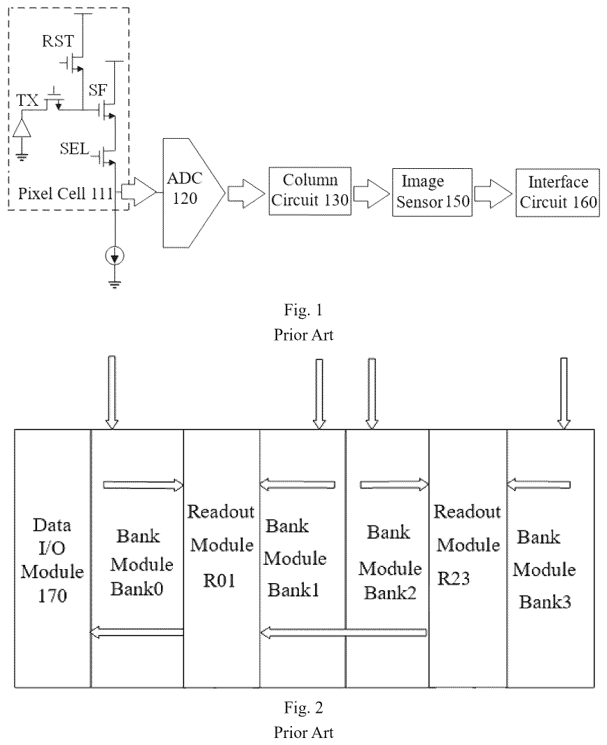

Reference is first made to FIG. 2, which schematically illustrates data signal flow in a column circuit of an image sensor. As shown in FIG. 2, the column circuit includes, as an example, four bank modules Bank0, Bank1, Bank2 and Bank3, two readout modules R01 and R23 and a data input/output (I/O) module 170. The bank modules Bank0 and Bank1 share the readout module R01, and the bank modules Bank2 and Bank3 share the readout module R23. In other words, every two of the bank modules share a single one of the readout modules. Data processing in the column circuit is roughly as described below. Gray-code encoded data GC from an analog-to-digital converter (ADC) 120 (not shown in FIG. 2; see FIG. 1 for details) and comparator data CMP are input as external data to the bank modules Bank0, Bank1, Bank2 and Bank3. The bank modules Bank0 and Bank1 provide the data that they have processed to the associated readout module R01 and then to the data I/O module 170, and the bank modules Bank2 and Bank3 provide the data that they have processed to the associated readout module R23 and then to the data I/O module 170 via the readout module R01. The readout modules R01 and R23 together provide shifted readout, and the data I/O module 170 receives the data that has been processed in the readout modules R01 and R23 and outputs it from the column circuit 130.

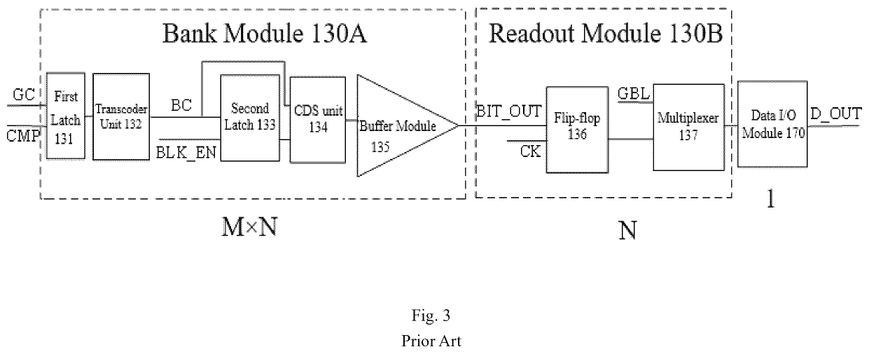

Reference is now made to FIG. 3, which schematically illustrates the topology of a column circuit in a conventional image signal processor (ISP). As shown in FIG. 3, in this example, the column circuit 130 includes M×N bank modules (in FIG. 3, only an i-th bank module 130A is schematically shown; 1≤i≤(M×N)), N readout modules (in FIG. 3, only a j-th readout module 130B is schematically shown; 1≤j≤N) and a data I/O module 170. Associated data processing is roughly as described below. Gray-code encoded data GC is latched in a first latch 131 at a falling edge of a signal of comparator data CMP, and a transcoder unit 132 then converts the latched Gray-code encoded data GC into binary data BC. A second latch 133 latches a black-level signal from an image sensor when a black-level enable signal BLK_EN is high, and a correlated double sampling (CDS) unit 134 applies CDS processing to the stored black-level signal and pixel-level data when the black-level enable signal BLK_EN is low. A buffer module 135 transmits a data signal BIT_OUT resulting from the CDS processing from the bank module 130A to the associated readout module 130B. Similarly, the N readout modules together serve as a shift register. Further, the readout module 130A first sends data from the bank module 130A and a bank module sharing the readout module 130A with the bank module 130A (not shown in FIG. 3; e.g., like the bank modules Bank0 and Bank1 that share the readout module R01 in FIG. 2) through a flip-flop 136 (e.g., a D-type flip-flop (DFF)) and a multiplexer 137. Immediately after that, the multiplexer 137 is switched to an output signal terminal GBL of an adjacent readout module. The readout module 130B outputs data from other bank modules through the multiplexer 137 (e.g., like the case shown in FIG. 2, in which data from the bank modules Bank2 and Bank3 that share the readout module R23 is passed to the readout module R23 and then to the readout module R01) and then from the column circuit 130 through the data I/O module 170.

It should be noted that only aspects of the column circuits that are relevant to the present invention are described herein, and reference is made to related techniques known to those skilled in the art for more details of other aspects not mentioned therein to get a better understanding.

As can be seen from FIG. 3, conventional column circuits usually include a data I/O module 170, N readout modules 130B and M×N bank modules 130A (both M and N depend on the resolution of the image sensor). Most functions are performed by the bank modules 130A. The inventors have conducted extensive research and thereby found that circuits with complex functions, such transcoder units 132 and CDS units 134, are typically composed of a large number of transistors. Such complex functions, coupled with a great number of bank modules 130A, often make the column circuits 130 have a large footprint and barely suitable for use in low-cost image sensor products.

Based on these findings, it is a principal object of the present invention to provide a column circuit, image sensor and imaging device. According to the present invention, the column circuit has a significantly reduced area and good performance and can significantly reduce the cost of an image sensor employing it.

It should be noted that the proposed column circuit and chip can be used in the proposed image sensor and imaging device. Additionally, the proposed image sensor can be used in the proposed imaging device. It will be understood that, as used herein, the terms “imaging device” or the like encompass general imaging devices, including but not limited to, cameras, video cameras, mobile phones, tablet computers, learning assistants, and medical imaging devices equipped with an image sensor, for example.

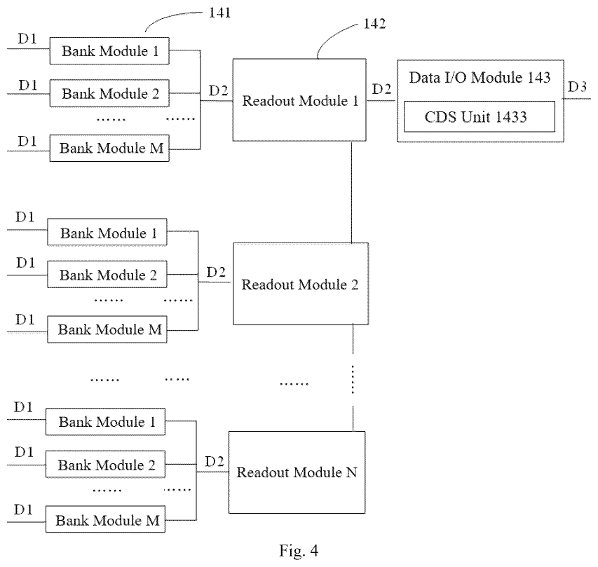

To this end, the present invention provides a column circuit. For example, reference is made to FIG. 4, a schematic block diagram of a column circuit embodying the present invention. As shown in FIG. 4, a column circuit 140 for use in an image sensor according to the present invention includes M×N bank modules 141, N readout modules 142 and a data I/O module 143. In this column circuit, a CDS unit 1433 is incorporated in the data I/O module 143. A first terminal of each bank module 141 is configured to receive a first data signal D1, and a second terminal thereof is coupled to a first terminal of an associated one of the readout modules 142, with a second terminal of the readout module 142 being coupled to the data I/O module 143, where M≥2. Additionally, the bank modules 141 are configured to convert the received first data signals D1 into second data signals D2, and the readout modules 142 are configured to pass the received second data signals D2 on to the data I/O module 143. The data I/O module 143 is configured to apply CDS processing to the second data signals D2 by the CDS unit 1433 and output third data signals D3 resulting from the processing.

Thus, differing from conventional designs with CDS units being incorporated in bank modules, the column circuit of the present invention incorporates a CDS unit 1433 in the data I/O module 143. This design fully leverages the fact that the number of data I/O modules 143 is much less than that of bank modules 141 to significantly reduce the number of CDS units 1433, resulting in cost savings and reducing the circuit area that they occupy. Accordingly, the footprint of the column circuit can be significantly reduced while ensuring its good performance. The cost of an image sensor employing this proposed column circuit can be significantly reduced, and the column circuit can be suitably used in low-cost image sensors.

In particular, compared with conventional designs with CDS units being incorporated in bank modules, the column circuit proposed herein saves (M×N−1) CDS units 1433 through incorporating a CDS unit 1433 in the data I/O module 143.

Preferably, in some exemplary embodiments, the CDS unit 1433 includes a plurality of first transistors (not shown in FIG. 4). This design with the CDS unit 1433 being constructed of a plurality of first transistors provides ease of implementation. It should be noted and understood by those skilled in the art that although the CDS unit 1433 has been described above as being implemented by first transistors, this merely represents a preferred illustrative embodiment and is not intended to limit the invention in any sense. The present invention is not limited to any particular implementation of the CDS unit 1433, and reference is made to related techniques known to those skilled in the art for more details of the CDS unit 1433, and further detailed description thereof is omitted herein for the sake of brevity.

For example, if each CDS unit 1433 includes P first transistors, totally M×N×P first transistors would be required in the conventional design that incorporates CDS units in bank modules 141. In contrast, only P first transistors are required in the proposed column circuit. Therefore, the present invention saves at least (M×N−1)×P transistors, compared with the prior art.

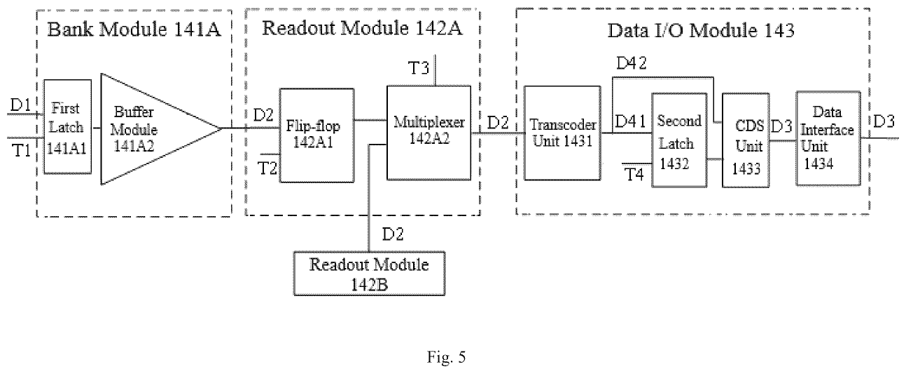

For example, reference is made to FIG. 5, which schematically illustrates the topology of a specific example of the proposed column circuit, in which only an i-th bank module 141A and a j-th readout module 142A are shown, as an example. As shown in FIG. 5, in the proposed column circuit, each bank module 141A includes, connected in sequence, a first latch 141A1 and a buffer unit 141A2, and each readout module 142A includes, connected in sequence, a flip-flop 142A1 and a multiplexer 142A2. The data I/O module 143 includes, connected in sequence, a transcoder unit 1431, a second latch 1432, a CDS unit 1433 and a data interface unit 1434. The first latch 141A1 is configured to, when receiving a first control signal T1 from an image sensor (e.g., in the form of comparator data CMP), latch the first data signal D1 (e.g., a voltage signal in a Gray code format, which represents an output voltage from a pixel) and provide the latched first data signal D1 to the buffer unit 141A2. The buffer unit 141A2 is configured to buffer the first data signal D1, obtaining a second data signal D2 (e.g., a voltage signal in a Gray code format, which represents the output voltage from the pixel) and transmit the second data signal D2 to the flip-flop 142A1. The flip-flop 142A1, when receiving a second control signal T2 from the image sensor (e.g., a readout clock signal), passes the second data signal D2 on to the multiplexer 142A3. The multiplexer 142A3 is configured to select the second data signal D2 based on a third control signal T3 from the image sensor (e.g., a bank module select signal) and provide it to the transcoder unit 1431. The transcoder unit 1431 is configured to transcode the second data signal D2 into a first set of fourth data signals D41 for transmission to the second latch 1432 (e.g., binary voltage signals representing a voltage of a black-level signal). After obtaining the first set of fourth data signals D41, it is also configured to transcode the subsequently received second data signal D2 into a second set of fourth data signals D42 for transmission to the CDS unit 1433 (binary voltage signals representing the voltage from the image pixel). The second latch 1432 is configured to, when receiving a fourth control signal T4 (e.g., a black-level enable signal), latch the first set of fourth data signals D41. The CDS unit 1433 is configured to perform CDS processing on the first set of fourth data signals D41 and the second set of second data signals D22, producing third data signals D3 (binary voltage signals).

In the proposed column circuit, each bank module 141A includes a first latch 141A1 and a buffer unit 141A2. The first latch 141A1 ensures stability of first data signals D1 passed therethrough. Through buffering the first data signals D1 in the buffer modules 141A2, it is ensured that the resulting second data signals D2 are robustly transferred from the bank modules coupled to the readout module 142A to the flip-flop 142A1. Additionally, in the column circuit, each readout module 142A includes, connected in sequence, a flip-flop 142A1 and a multiplexer 142A2. The flip-flops 142A1 can synchronize switching and readout timing of the multiplexers 142A2 in the readout modules 142, enabling multiplexers 142A2 to select and output second data signals D2 from an appropriate one of the readout modules 142 (e.g., the multiplexers 142A2 may be able to selectively output second signal data D2 from the readout module 142A or from another readout module 142C). Further, the data I/O module 143 includes a transcoder unit 1431, a second latch 1432, a CDS unit 1433 and a data interface unit 1434. The transcode module 1431 converts a second data signal D2 into first and second sets of fourth data signals D41, D42, laying a solid foundation for efficient data signal processing by the second latch 1432. The second latch 142B4 can lay a solid foundation for suppression of fixed-pattern noise and reset noise in the resulting third data signal by the CDS unit 143 and hence for improved image quality.

Preferably, still in the context of the readout module 142A as an example, an input terminal of the multiplexer 142A2 is coupled to an output terminal of the flip-flop 142A2 in the readout module 142A, and another input terminal of the multiplexer 142A3 is coupled to the output terminal of the multiplexer (not shown in FIG. 5) in another readout module 142C that is adjacent to the readout module 142A. Further, most of the readout modules 142 are coupled to the data I/O module 143 via the multiplexers in the other readout modules 142, which are adjacent to respective those readout modules 142, with the output terminal of the multiplexer in the last one of the readout modules 142 being directly connected to the data I/O module 143.

For example, in some exemplary embodiments, the second data signals D2 are encoded using Gray code, and the first and second sets of fourth data signals D41, D42 and the third data signals D3 are binary encoded. Encoding the first data signals D1 in a Gray code format can effectively reduce transmission errors, and the binary encoded first and second sets of fourth data signals D41, D42 and third data signals D3 can be subsequently processed in the readout modules in a more efficient manner. It should be noted and understood by those skilled in the art that the present invention is not limited to any particular format of the Gray-code encoded first data signals D1 or the binary encoded first and second sets of fourth data signals D41, D42 or third data signals D3. In practical implementations of the present invention, any appropriate format may be employed, as required.

For example, in some exemplary embodiments, examples of the flip-flops 142A1 may include, but are not limited to, D-type flip-flops. In the proposed column circuit, designing the flip-flops 142A2 in the readout modules 142A as D-type flip-flops ensures desirable serial transmission of the second data signals D2.

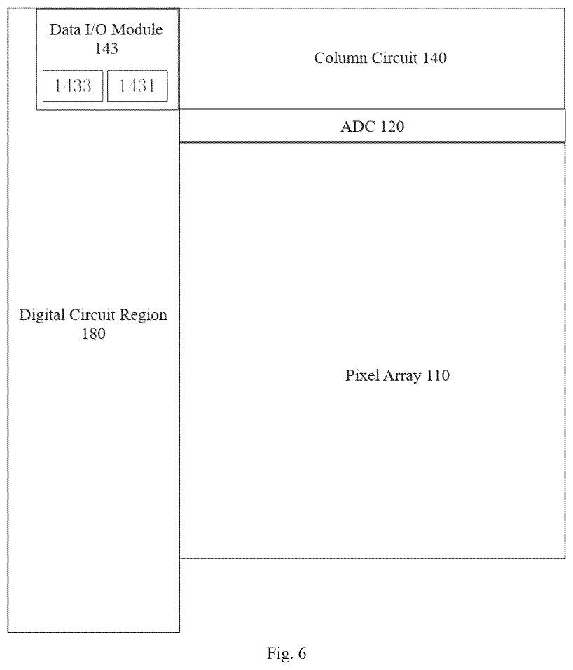

Preferably, in some exemplary embodiments, the transcoder unit 1431 includes a plurality of second transistors (not shown in FIG. 6). This design with the transcoder unit 1431 being constructed of a plurality of second transistors is advantageous in simple logic and ease of implementation. It should be noted and understood by those skilled in the art that although the transcoder unit 1431 has been described above as being implemented by second transistors, this merely represents a preferred illustrative embodiment and is not intended to limit the invention in any sense. The present invention is not limited to any particular implementation of the transcoder unit 1431, and reference is made to related techniques known to those skilled in the art for more details of the transcoder unit 1431, and further detailed description thereof is omitted herein for the sake of brevity.

For example, if the CDS unit 1433 includes P first transistors and the transcoder unit 1431 includes Q second transistors, totally M×N×P first transistors and M×N×Q second transistors would be required in the conventional design with both transcoder units 1431 and CDS units 1433 being incorporated in bank modules 141. In contrast, only P first transistors and Q second transistors are required by the two types of units in the proposed column circuit. Therefore, the present invention can save approximately (M×N−1)×(P+Q) transistors, compared with the prior art.

As can be seen from the above description, since a transcoder unit 1431 and a CDS unit 1433 are both incorporated in a data I/O module 143 in the proposed column circuit, more data is output from the bank modules 141A, compared with the conventional design. Although performance of the column circuit could be further improved by selecting the buffer units 141A2 as ones with higher performance and supporting a greater bit-width of data, it is still considered overall cost-effective.

It should be noted and understood by those skilled in the art that the present invention is not limited to any particular type of image sensor. As a non-limiting example, the image sensor may be a CMOS image sensor. Additionally, the present invention is not limited to any particular value of M, N, P or Q. Preferably, the values of M and N are dependent on the resolution of the image sensor. In practical implementations of the present invention, the values may be appropriately determined, as required.

In a second embodiment of the present invention, there is provided a chip for use in an image sensor, on which a column circuit as defined in any of the foregoing embodiments is integrated. Through integrating the column circuit of the invention onto the chip, not only the cost of the image sensor can be reduced, its degree of integration can also be increased.

In a third embodiment of the present invention, there is provided an image sensor including a column circuit or chip as defined in any of the foregoing embodiments. As an example, reference is made to FIG. 6, a schematic block diagram of an imaging device according to an exemplary embodiment of the present invention. As can be seen from FIG. 6, the image sensor further includes a digital circuit region 180 and a pixel array 110. The data I/O module 143 in the column circuit 140 is arranged in the digital circuit region 180. The digital circuit region 180 typically consists of digital circuit modules designed using hardware description languages such as Verilog. The pixel array 110 is configured to convert image light signals that it collects into first data signals as described above, and the column circuit is configured to convert the first data signals into second data signals as described above, which are in turn converted by the data I/O module 143 in the digital circuit region 180 into third data signals as described above. The third data signals are processed by an ISP, obtaining a target image of an object being captured.

The image sensor of the present invention is designed so that the data I/O module 143 is arranged in the digital circuit region 180 that provides circuit functions typically by means of programming. This enables an additionally simplified design and increased flexibility. Additionally, since the image sensor of the present invention is of the same inventive concept as the column circuit of the present invention, it provides at least all the advantages of the column circuit. Such advantages have been described in detail above in connection with the column circuit embodiments and are not repeated herein, and reference is made to the above description for more details.

Notably, as described above (e.g., with reference to FIG. 1), the image sensor may further include an analog-to-digital converter (ADC) 120, which is coupled between the pixel array 110 and the column circuit 140 and used for further ISP of the third data signals (not shown in FIG. 6). For more details of the image sensor, reference is made to related techniques known to those skilled in the art, and further description thereof is omitted herein for the sake of brevity.

Preferably, in some exemplary embodiments, the data I/O module 143 is implemented in the digital circuit region using a design tool for digital chips. It should be noted and understood by those skilled in the art that the present invention is not limited to any particular such design tool, and non-limiting examples thereof may include RTL and APR tools. For example, the transcoder unit 1431 and the CDS unit 1433 may be implemented in the digital circuit region 180 using RTL and APR tools.

In a fourth embodiment of the present invention, there is provided an imaging device including a column circuit, chip or image sensor as defined in any of the foregoing embodiments. This imaging device is of the same inventive concept as the image sensor of the present invention, which is in turn of the same inventive concept as the column circuit of the invention. Therefore, the imaging device provides at least all the advantages of the column circuit. Such advantages have been described in detail above in connection with the column circuit embodiments and are not repeated herein, and reference is made to the above description for more details.

The column circuit, chip, image sensor and imaging device of the present invention offer the benefits as follows over the prior art. Differing from conventional designs with CDS units being incorporated in bank modules, the column circuit of this invention incorporates a CDS unit in a data I/O module. This design fully leverages the fact that the number of data I/O modules is much less than that of bank modules to significantly reduce the number of CDS units, resulting in cost savings and reducing the circuit area that they occupy. Accordingly, the footprint of the column circuit can be significantly reduced while ensuring its good performance. The cost of an image sensor employing this proposed column circuit can be significantly reduced, and the column circuit can be suitably used in low-cost image sensors.

Further, the various functional modules in the embodiments disclosed herein may be integrated into a discrete component, or provided as separate modules. Alternatively, two or more such modules may be integrated into a discrete component.

The description presented above is merely that of a few preferred embodiments of the proposed column circuit, chip, image sensor and imaging device and is not intended to limit the scope thereof in any sense. Any and all changes and modifications made by those of ordinary skill in the art in light of the above teachings fall within the scope as defined in the appended claims. Apparently, those skilled in the art can make various modifications and variations to the present invention without departing from the spirit and scope thereof. Accordingly, the invention is intended to embrace all such modifications and variations if they fall within the scope of the appended claims and equivalents thereof.

What is claimed is:

1. A column circuit for use in an image sensor, the column circuit comprising M×N bank modules, N readout modules and a data input/output (I/O) module, the column circuit further comprising a correlated double sampling (CDS) unit arranged in the data I/O module, a first terminal of each bank module configured to receive a first data signal, a second terminal of each bank module coupled to a first terminal of an associated one of the readout modules, a second terminal of each readout module coupled to the data I/O module, where M≥2,
the bank modules configured to convert the received first data signals into second data signals, the readout modules configured to receive the second data signals and transmit the received second data signals to the data I/O module, the data I/O module configured to obtain third data signals from CDS processing by the CDS unit and output the third data signals.

2. The column circuit according to claim 1, wherein the CDS unit comprises a plurality of first transistors.

3. The column circuit according to claim 1, wherein each bank module comprises, connected in sequence, a first latch and a buffer unit, and each readout module comprises, connected in sequence, a flip-flop and a multiplexer, the data I/O module comprising, connected in sequence, a transcoder unit, a second latch, the CDS unit and a data interface unit,
the first latch configured to, when receiving a first control signal from the image sensor, latch the first data signal and provide the latched first data signal to the buffer unit, the buffer unit configured to buffer the first data signal and thereby obtain second data signals and provide the second data signals to the flip-flop,
the flip-flop, when receiving a second control signal from the image sensor, passing the second data signals on to the multiplexer, the multiplexer configured to select one of the second data signals according to a third control signal from the image sensor and provide the selected second data signals to the transcoder unit, the transcoder unit configured to transcode the second data signal into a first set of fourth data signals for transmission to the second latch and, after obtaining the first set of fourth data signals, transcode a subsequently received one of the second data signals into a second set of fourth data signals for transmission to the CDS unit, the second latch configured to, when receiving a fourth control signal, latch the first set of fourth data signals, the CDS unit configured to perform CDS processing on the first set of fourth data signals and the second set of fourth data signals, thereby obtaining the third data signals.

4. The column circuit according to claim 3, wherein the transcoder unit comprises a plurality of second transistors.

5. The column circuit according to claim 3, wherein the second data signals are encoded using Gray code, and wherein the first set of fourth data signals, the second set of fourth data signals and the third data signals are binary encoded.

6. A chip for use in an image sensor, the column circuit according to claim 1 is integrated on the chip.

7. An image sensor, comprising a chip, wherein the chip comprises the column circuit according to claim 1.

8. The image sensor according to claim 7, further comprising a digital circuit region and a pixel array, wherein the data I/O module of the column circuit is arranged in the digital circuit region;
the pixel array is configured to convert image light signals that it collects into the first data signals; the column circuit is configured to convert the first data signals into the second data signals, which are in turn converted by the data I/O module in the digital circuit region into the third data signals; and an image signal processor (ISP) is configured to process the third data signals and thereby obtain a target image of an object being captured.

9. The image sensor according to claim 8, wherein the data I/O module is implemented in the digital circuit region using a design tool for digital chips.
